(19) United States
(12) Patent Application Publication
(10) Pub. No.: US 2019/0122661 A1
(43) Pub. Date: Apr. 25, 2019

(54) SYSTEM AND METHOD TO DETECT CUES IN CONVERSATIONAL SPEECH

(71) Applicant: GM GLOBAL TECHNOLOGY OPERATIONS LLC, Detroit, MI (US)

(72) Inventors: Cody R. Hansen, Shelby Township, MI (US); Gaurav Talwar, Novi, MI (US); Dustin H. Smith, Auburn Hills, MI (US); XU FANG ZHAO, Toronto (CA)

(21) Appl. No.: 15/790,207

(22) Filed: Oct. 23, 2017

(51) Int. Cl. G10L 15/22; G10L 25/63; G10L 15/18; G10L 15/30; G10L 15/183

(52) U.S. Cl. CPC G10L 15/22; G10L 25/63; G10L 15/1815; G10L 2015/088; G10L 15/183; G10L 2015/223; G10L 15/30

(57) ABSTRACT

One general aspect includes a method for detecting one or more cues in conversational speech, the method including: recognizing (via a controller) a conversation between a vehicle occupant and at least one third party; reviewing silently (via the controller) the conversation in real-time; receiving (at a controller) from the vehicle occupant or the third party a speech cue made during the conversation; in response to the received speech cue, retrieving suggestion information based on the silent review of the conversation (via the controller) from one or more suggestion databases; providing (via the controller) an audio announcement of the suggestion information configured to be announced through an audio system located in a vehicle.

### INTRODUCTION

Interactive voice response technology allows vehicle occupants to vocally interact with a backend computer through the use of their telematics system and as if the backend computer is a person. This technology also helps the vehicle occupants accomplish tasks on the go. For instance, while driving from one location to another, the vehicle operator may activate the backend computer to attain suggestions for nearby restaurants without needing to take their eyes off the road. The vehicle operator and backend computer may also interact back and forth with each other to figure out with kinds of restaurants are most desired by the operator. This works great when there is one person trying to get suggestions. However, an issue can sometimes arise when there are multiple parties conversing with each other while trying to come to an agreement but still needing suggestions. The parties are forced to pause or temporarily end their conversation so that one party can activate and interact with the supporting backend computer. This can create the inconvenience for the communicating party in needing to try to remember and repeat parts of the conversation to help the backend computer find suggestions. This situation also allows much room for error in mental retention on the part of the party trying to work with the backend computer and provides the communicating party the unfair advantage of being in control of feeding the information to the backend computer. It is therefore desirable to provide a system which can provide adequate suggestions to conversing parties without causing them to interrupt their conversation as well as forcing them to repeat parts of the conversation from memory.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for detecting one or more cues in conversational speech, the method including: recognizing (via a controller) a conversation between a vehicle occupant and at least one third party; reviewing silently (via the controller) the conversation in real-time; receiving (at a controller) from the vehicle occupant or the third party a speech cue made during the conversation; in response to the received speech cue, retrieving suggestion information based on the silent review of the conversation (via the controller) from one or more suggestion databases; providing (via the controller) an audio announcement of the suggestion information configured to be announced through an audio system located in a vehicle. Other embodiments of this aspect include corresponding computer systems, apparatus, and computer programs recorded on one or more computer storage devices, each configured to perform the actions of the methods.

Implementations may include one or more of the following features. The method further including: determining (via the controller) whether the vehicle occupant or the third party has, at least in part, confirmed the suggestion information after being announced through the audio system; and contacting (via the controller) one or more service providers in response to a positive determination that the vehicle occupant or the third party has, at least in part, confirmed the suggestion information. The method where the step of reviewing silently the conversation in real-time further includes implementing one or more conversational context-specific language models to identify a conversational context for, at least a portion of, the conversation. The method may also include the step of retrieving suggestion information from one or more suggestion databases being further based on the conversational context of the conversation. The method where the step of reviewing silently the conversation in real-time further includes implementing one or more emotional context-specific language models to identify an emotional context for, at least a portion of, the conversation. The method may also include the step of retrieving suggestion information from one or more suggestion databases being further based on the emotional context of the conversation. The method where the speech cue is a query configured to initiate the controller to retrieve suggestion information. The method where the at least one third party is another vehicle occupant. The method where the controller implements an automated voice response system (VRS) to recognize the speech cue from the vehicle occupant or the third party and provide the suggestion information through the audio system. Implementations of the described techniques may include hardware, a method or process, or computer software on a computer-accessible medium.

One general aspect includes a system for a detection of one or more cues in conversational speech, the system including: an audio system located in a vehicle, the audio system configured to announce information; a memory configured to include one or more executable instructions; a controller configured to execute the executable instructions; and where the executable instructions enable the controller to: recognize a conversation between a vehicle occupant and at least one third party, silently review the conversation in real-time for a speech cue, receive the speech cue from the vehicle occupant or the third party, in response to the received speech cue, retrieve suggestion information based on the silent review of the conversation from one or more suggestion databases, and provide an audio announcement of the suggestion information configured to be announced through an audio system located in a vehicle. Other embodiments of this aspect include corresponding computer systems, apparatus, and computer programs recorded on one or more computer storage devices, each configured to perform the actions of the methods.

Implementations may include one or more of the following features. The system where the executable instructions further enable the controller to determine whether the vehicle occupant or the third party has, at least in part, confirmed the suggestion information after being announced through the audio system. The system may also include contact one or more service providers in response to a positive determination that the vehicle occupant or the third party has, at least in part, confirmed the suggestion information. The system where: the silent review the conversation further includes the implementation of one or more conversational context-specific language models to identify a conversational context for, at least a portion of, the conversation. The system may also include the retrieval of suggestion information from the one or more suggestion databases is further based on the conversational context of the conversation. The system where the speech cue is a query configured to initiate the controller to retrieve suggestion information. The system where the at least one third party is another vehicle occupant. The system where the at least one third party is a mobile computing device user. The system where the controller implements an automated voice response system (VRS) to recognize the speech cue from the vehicle occupant or the third party and provide the suggestion information through the audio system. Implementations of the described techniques may include hardware, a method or process, or computer software on a computer-accessible medium.

One general aspect includes a non-transitory and machine-readable medium having stored thereon executable instructions adapted to detect one or more cues in conversational speech, which when provided to a controller and executed thereby, causes the controller to: recognize a conversation within a cabin of a vehicle, the conversation between a vehicle occupant and at least one third party; silently review the conversation in real-time for a speech cue; receive the speech cue from the vehicle occupant or the third party; in response to the received speech cue, retrieve suggestion information based on the silent review of the conversation from one or more suggestion databases; provide an audio announcement of the suggestion information configured to be announced through an audio system located in a vehicle. Other embodiments of this aspect include corresponding computer systems, apparatus, and computer programs recorded on one or more computer storage devices, each configured to perform the actions of the methods.

Implementations may include one or more of the following features. The non-transitory and machine-readable medium further causes the controller to determine whether the vehicle occupant or the third party has, at least in part, confirmed the suggestion information after being announced through the audio system, and contact one or more service providers in response to a positive determination that the vehicle occupant or the third party has, at least in part, confirmed the suggestion information. The non-transitory and machine-readable medium where: the silent review the conversation further includes the implementation of one or more conversational context-specific language models to identify a conversational context for, at least a portion of, the conversation, and the retrieval of suggestion information from the one or more suggestion databases is further based on the conversational context of the conversation. The non-transitory and machine-readable medium where the speech cue is a query configured to initiate the controller to retrieve suggestion information. The non-transitory and machine-readable medium where the at least one third party is another vehicle occupant. The non-transitory and machine-readable medium where the controller implements an automated voice response system (VRS) to recognize the speech cue from the vehicle occupant or the third party and provide the suggestion information through the audio system. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system that is capable of utilizing the system and method disclosed herein;

FIG. 2 is a is a block diagram depicting an embodiment of an automatic speech recognition (ASR) system; and

FIG. 3 is a flow chart depicting an embodiment of a method of detecting one or more cues in conversational speech.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The system and method described below detects cues in conversational speech and provides one or more suggestions based on such cues without the conversing parties needing to repeat parts of the conversation. As such, when a vehicle occupant and at least one third party (one who may also be occupying the vehicle cabin or may be conversing with the vehicle occupant through the hands-free phone system option of the telematics unit) converse, a voice response system (VRS), with an automated speech recognition system (ASR) installed thereon, can passively listen to the conversation for information (e.g., speech data) which would potentially be relevant to helping the vehicle occupant achieve an end goal. Moreover, the ASR can implement one or more conversational context-specific language models and/or emotional context-specific language models to classify the conversation context as well as piece together conversational information so as to provide one or more context-based suggestions. In essence, the system and method offer ways to accommodate the vehicle occupant and/or third party without having to further explain what they desire, since potentially relevant pieces of data have previously been gathered in support of providing suggestions. For instance, the ASR will recognize that a conversation has begun between two parties (e.g., by recognizing the voice tones and inflections as well as speech patterns for two different people). The ASR will then silently review the conversation in real-time (i.e., while it's happening) while also running the decoded speech through language models to determine the context of the conversation and emotion of the participants. The ASR may moreover listen for key words. The contextual information and keyword information is then saved until it may be needed. If/when one of the conversation participants activates the VRS through a speech cue such as an inquiry regarding a third-party service provider, the VRS can access and collect the saved contextual information and/or keyword information to assist the VRS in providing one or more suggestions to the participants. For example, when the vehicle occupant requests “Hey VRS, please help me and Scott find a hotel near tonight's meeting?”, the VRS can access the conversation information and subsequently access a suggestion database and use the conversation information to determine the location of the meeting as well as the type of hotel desired by the vehicle occupant and the third party (i.e., Scott). The suggestion database may additionally retrieve previous preference information and/or conversation information to help determine the meeting location and hotel type. The VRS can then generate suggestions from the database based on the conversation information. As a result, the VRS may respond with a suggestion in a format such as “I found a Courtyard Marriot with great review that is five (5) minutes away from the meeting in Vernon, Ill. which has vacant rooms for $130 a night—shall I book it now?” If the vehicle occupant or third party respond in the affirmative, then the VRS may contact the service provider to request and/or negotiate a room reservation.

### Communication System

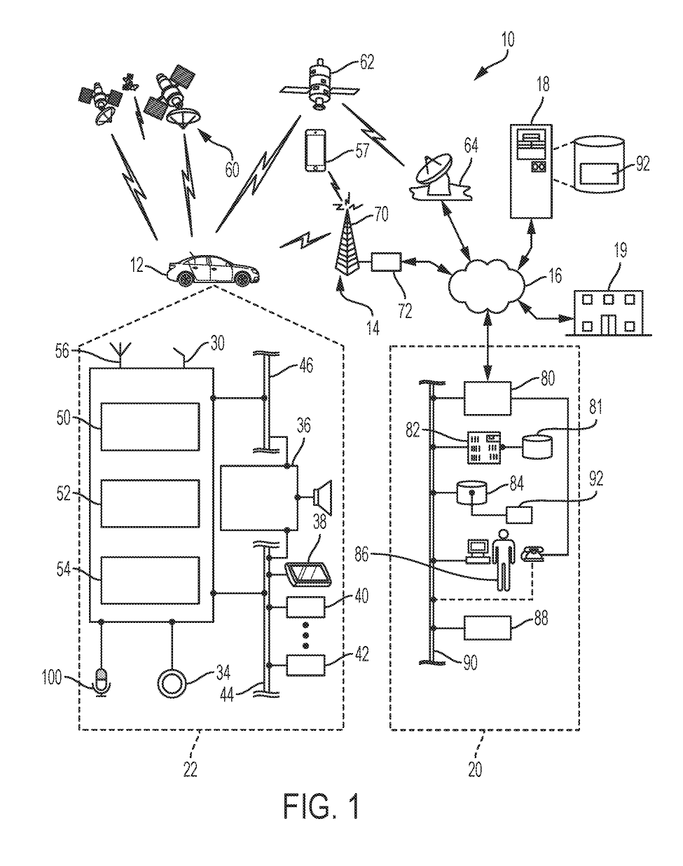

With reference to FIG. 1, there is shown an operating environment that includes, among other features, a mobile vehicle communications system 10 and that can be used to implement the method disclosed herein. Communications system 10 generally includes a vehicle 12, one or more wireless carrier systems 14, a land communications network 16, a remotely located computer 18, and a data center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including, but not limited to, motorcycles, trucks, busses, sports utility vehicles (SUVs), recreational vehicles (RVs), construction vehicles (e.g., bulldozers), trains, trolleys, marine vessels (e.g., boats), aircraft, helicopters, amusement park vehicles, farm equipment, golf carts, trams, etc., can also be used. Some of the vehicle features are generally shown in FIG. 1 and include a radio 13 configured to include one or more presets, a vehicle seat 15, and vehicle HVAC system 17. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit 30 such as, for example, the microphone 32 and pushbutton(s) 34, whereas others are indirectly connected using one or more network connections, such as a communications bus 44 or an entertainment bus 46. Examples of suitable network connections include a controller area network (CAN), WIFI, Bluetooth and Bluetooth Low Energy, a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket transceiver device that is installed in the vehicle and that enables wireless voice and/or data communication over wireless carrier system 14 and via wireless networking. This enables the vehicle to communicate with data center 20, other telematics-enabled vehicles, or some other entity or device. The telematics unit 30 preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor 86 or voice response unit at the data center 20) and data communication (e.g., to provide GPS location data or vehicle diagnostic data to the data center 20), the system can utilize a single call over a voice channel and switch as needed between voice and data transmission over the voice channel, and this can be done using techniques known to those skilled in the art.

According to one embodiment, telematics unit 30 utilizes cellular communication according to standards such as LTE or 5G and thus includes a standard cellular chipset 50 for voice communications like hands-free calling, a wireless modem for data transmission (i.e., transceiver), an electronic processing device 52, at least one digital memory device 54, and an antenna system 56. It should be appreciated that the modem can either be implemented through software that is stored in the telematics unit and is executed by processor 52, or it can be a separate hardware component located internal or external to telematics unit 30. The modem can operate using any number of different standards or protocols such as, but not limited to, WCDMA, LTE, and 5G. Wireless networking between vehicle 12 and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a mobile computing device 57, such as a smart phone, personal laptop computer, smart wearable device, or tablet computer having two-way communication capabilities, a netbook computer, or any suitable combinations thereof. The mobile computing device 57 can include computer processing capability, memory, a transceiver capable of communicating with wireless carrier system 14, a user interface, a microphone and audio system, and/or a GPS module capable of receiving GPS satellite signals and generating GPS coordinates based on those signals. The mobile computing device 57 has the ability to store one or more interfaces which responds to voice commands such as, but not limited to, an automated voice response system (VRS) 88 (discussed below). The user interface may be embodied as a touch-screen graphical interface capable of user interaction as well as displaying information. Examples of the mobile computing device 57 include the iPhone™ manufactured by Apple, Inc. and the Droid™ manufactured by Motorola, Inc. as well as others. While the mobile computing device 57 may include the ability to communicate via cellular communications using the wireless carrier system 14, this is not always the case. For instance, Apple manufactures devices such as the various models of the iPad™ and iPod Touch™ that include the processing capability, interface, and the ability to communicate over a short-range wireless communication link. However, the iPod Touch™ and some iPads™ do not have cellular communication capabilities. Even so, these and other similar devices may be used or considered a type of wireless device, such as the mobile computing device 57, for the purposes of the method described herein.

Mobile device 57 may be used inside or outside of vehicle 12, and may be coupled to the vehicle by wire or wirelessly. The mobile device also may be configured to provide services according to a subscription agreement with a third-party facility or wireless/telephone service provider. It should be appreciated that various service providers may utilize the wireless carrier system 14 and that the service provider of the telematics unit 30 may not necessarily be the same as the service provider of the mobile devices 57. When using a short-range wireless connection (SRWC) protocol (e.g., Bluetooth/Bluetooth Low Energy or Wi-Fi), mobile computing device 57 and telematics unit 30 may pair/link one with another, and thus become bonded, when within a wireless range (e.g., prior to experiencing a disconnection from the wireless network)—as is generally known to skilled artisans.

Telematics Controller 52 (processor) can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Telematics Controller 52 executes various types of digitally-stored instructions, such as software or firmware programs stored in memory 54, which enable the telematics unit to provide a wide variety of services. For instance, controller 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services provided in connection with one or more vehicle system modules 42 (VSM); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit 30 is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to data center 20 or other remote computer system, such as computer 18, for other purposes, such as fleet management. Also, new or updated map data can be downloaded to the GPS module 40 from the data center 20 via the telematics unit 30.

Apart from the audio system 36 and GPS module 40, the vehicle 12 can include other VSMs 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests.

As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art.

The pushbutton(s) 34 allow manual user input into the telematics unit 30 to initiate wireless telephone calls and provide other data, response, or control input. Separate pushbuttons can be used for initiating emergency calls versus regular service assistance calls to the data center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM, media streaming services (e.g., PANDORA RADIO™, SPOTIFY™, etc.), satellite radio, CD, DVD, and other multimedia functionality. This functionality can be provided in conjunction with or independent of the infotainment module described above. Visual display 38 is preferably a graphics display, such as a touch screen on the instrument panel or a heads-up display (HUD) reflected off of the windshield, and can be used to provide a multitude of input and output functions (i.e., capable of GUI implementation). Audio system 36 may also generate at least one audio announcement to announce such third-party contact information is being exhibited on display 38 and/or may generate an audio announcement which independently announces the third-party contact information. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more cellular network infrastructures (CNI) 72, as well as any other networking components required to connect wireless carrier system 14 with land network 16. Each cell tower 70 includes sending and receiving antennas and a base station, with the base stations from different cell towers being connected to the CNI 72 either directly or via intermediary equipment such as a base station controller. Cellular system 14 can implement any suitable communications technology, including for example, analog technologies such as AMPS, or the newer digital technologies such as, but not limited to, 4G LTE and 5G. As will be appreciated by skilled artisans, various cell tower/base station/CNI arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to data center 20. For example, land network 16 may include a public switched telephone network (PSTN) such as that used to provide hardwired telephony, packet-switched data communications, and the Internet infrastructure (i.e., a network of interconnected computing device nodes). One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, data center 20 need not be connected via land network 16, but could include wireless telephony equipment so that it can communicate directly with a wireless network, such as wireless carrier system 14.

Remote computer 18 can be one of a number of computers accessible via a private or public network such as the Internet. Each such computer 18 can be used for one or more purposes, such as a web server accessible by the vehicle via telematics unit 30 and wireless carrier 14. Other such accessible remote computers 18 can be, for example: a service center computer (e.g., a SIP Presence server) where diagnostic information and other vehicle data can be uploaded from the vehicle via the telematics unit 30; a client computer used by the vehicle owner or other subscriber for such purposes as accessing or receiving vehicle data (such as, for example, vehicle feature data and popular configuration data) or to setting up or configuring subscriber preferences or controlling vehicle functions; or a third party repository to or from which vehicle data or other information is provided, whether by communicating with the vehicle 12 or data center 20, or both; for example, computer 18 can house suggestion database 92 (discussed below) onto its memory. A computer 18 can also be used for providing Internet connectivity such as DNS services or as a network address server that uses DHCP or other suitable protocol to assign an IP address to the vehicle 12.

Data center 20 is designed to provide the vehicle electronics 28 with a number of different system backend functions and, according to the exemplary embodiment shown here, generally includes one or more switches 80, servers 82, memory 84, live advisors 86, as well as a VRS 88 (i.e., the computer interface which responds to voice commands), all of which are known in the art. These various data center components are preferably coupled to one another via a wired or wireless local area network 90. Switch 80, which can be a private branch exchange (PBX) switch, routes incoming signals so that voice transmissions are usually sent to either the live adviser 86 by regular phone, backend computer 87, or to the automated voice response system 88 using VoIP. Server 82 can incorporate a data controller 81 which essentially controls the operations of server 82. Server 82 may control data information as well as act as a transceiver to send and/or receive the data information (i.e., data transmissions) from the memory 84, telematics unit 30, and mobile computing device 57.

Controller 81 is capable of reading executable instructions stored in a non-transitory machine readable medium and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components. The live advisor phone can also use VoIP as indicated by the broken line in FIG. 1. VoIP and other data communication through the switch 80 is implemented via a modem (i.e., a transceiver), connected between the land communications network 16 and local area network 90.

Data transmissions are passed via the modem to server 82 and/or memory 84. Memory 84 can store account information such as vehicle dynamics information and other pertinent subscriber information. Memory can also store one or more databases 92 that include information such as, but not limited to, suggestion information. As such, database 92 includes merchant, vendor, landmark information, or the like and of various popular varieties (e.g., restaurants, hotels, shops, dry-cleaning services, fast-food chains, ski lodges, car dealerships, etc.) and may list such information based on, but is not limited to, address, merchant type, phone number, or geocode. Database 92 may also be supported by one or more web mapping services to provide one or more accurate suggestion information. Database 92 can also include artificial intelligence-based executable instructions to enable VRS 88 to conduct a conversation through auditory methods which are designed to convincingly simulate how a human would behave as a conversational partner, as is generally known in the art (i.e., to act as a chatbot, talkbot, chatterbot, Bot, IM bot, interactive agent, or Artificial Conversational Entity), which may be used to assist in finding accurate information within the database. Database 92 may also correspond with other memory devices such as, but not limited to, telematics memory 54 or data center memory 84 to retrieve previously recorded. For example, database 92 may access previously recorded information such as, but not limited to, preference information or conversation information for either the vehicle occupant or the third party. As will be appreciated, suggestion information databases 92 are well known to collaborate with VRS 88 or a combination of VRS 88 and the live advisor 86.

Data transmissions may also be conducted by wireless systems, such as 802.11x, GPRS, and the like. Although the illustrated embodiment has been described as it would be used in conjunction with a manned data center 20 using live advisor 86, it will be appreciated that the data center can instead utilize VRS 88 as an automated advisor or, a combination of VRS 88 and the live advisor 86 can be used.

Service Provider 19 may be any commercial entity that provides services to consumers and is connected to network 16. For example, the service provider 19 may be a hotel that provides paid lodging on a short-term basis and includes one or more computers to communicate with data center 20 or telematics unit 30 through network 16 (e.g., to make a reservation). In another example, service provider 19 can be a car dealership that sells new or used cars at the retail level and can also include one or more computers to communicate with data center 20 or telematics unit 30 through network 16 (i.e., to make a vehicle maintenance reservation). In another example, the service provider 19 may be a restaurant that prepares and serves food and drinks to customers in exchange for money and includes one or more computers to communicate with data center 20 or telematics unit 30 through network 16 (e.g., to make a dinner reservation). As is appreciated by those skilled in the art, the above-mentioned services providers 19 are only examples of some of those that may be used in this communication system, as numerous others are also possible.

### Automatic Speech Recognition System

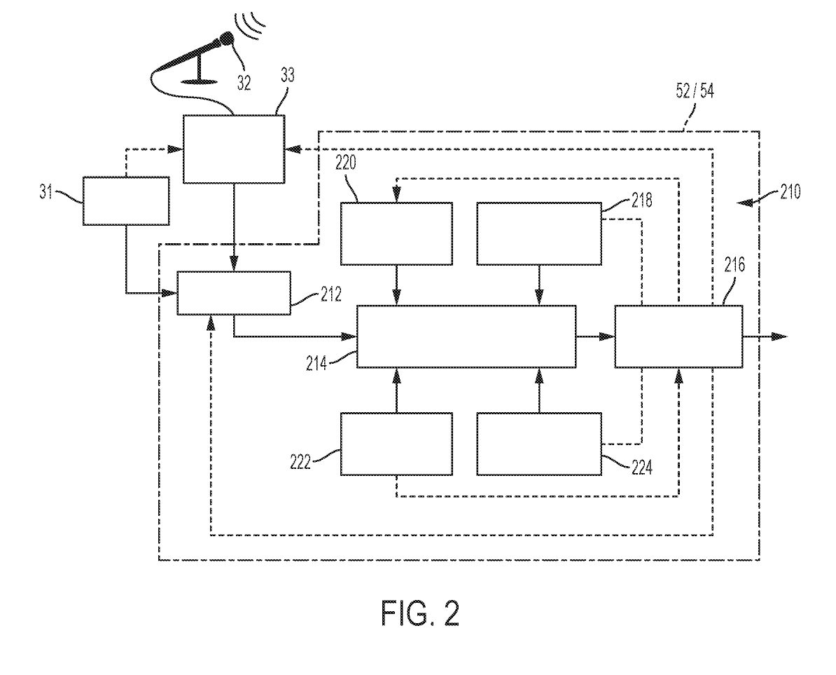

Turning now to FIG. 2, there is shown an illustrative architecture for an ASR system 210 that can be used to enable the presently disclosed method. In general, a vehicle occupant vocally interacts with an automatic speech recognition system (ASR) for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific illustrative ASR system 210. The system 210 includes a device to receive speech such as the telematics microphone 32, and an acoustic interface 33 such as a sound card of the telematics unit 30 having an analog to digital converter to digitize the speech into acoustic data. The system 210 also includes a memory such as the telematics memory 54, mobile device memory 57, memory 84, or the memory of computer 18 for storing the acoustic data and storing speech recognition software and databases, and a processor such as the telematics processor 52, mobile device processor 57, server 82, or computer 18 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances: and one or more post-processor software modules 216 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 214. First, grammar and/or lexicon model(s) 218 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 218 can include all commands known to and used by the system 210. In another example, if the system 210 is in a main menu mode, then the active grammar model(s) 218 can include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative illustrative embodiment, some or all of the ASR system 210 can be resident on, and processed using, computing equipment in a location remote from the vehicle 12 such as the call center 20. For example, grammar models, acoustic models, and the like can be stored in memory of one of the servers 82 and/or databases 84 in the call center 20 and communicated to the vehicle telematics unit 30 for in-vehicle speech processing. Similarly, speech recognition software can be processed using processors of one of the servers 82 in the call center 20. In other words, the ASR system 210 can be resident in the telematics unit 30, distributed across the call center 20 and the vehicle 12 in any desired manner, and/or resident at the call center 20.

First, acoustic data is extracted from human speech wherein a vehicle occupant speaks into the microphone 32, which converts the utterances into electrical signals and communicates such signals to the acoustic interface 33. A sound-responsive element in the microphone 32 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 212 transforms the continuous stream of digital speech data into discrete sequences of acoustic parameters. More specifically, the processor 52 executes the pre-processor module(s) 212 to segment the digital speech data into overlapping phonetic or acoustic frames of, for example, 10-30 in duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an MINI engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian MINI process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The MINI can also include a statistical distribution called a mixture of diagonal Gaussians, which yields a likelihood score for each observed feature vector of each subword, which scores can be used to reorder the N-best list of hypotheses. The MINI engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

The speech recognition decoder 214 may also incorporate one or more conversational context-specific language models to identify a conversational context corresponding to the feature vectors. Also, the conversational context can include “humor” for a humorous conversation, or “dinner” for a conversation about dinner plans, or “romantic” for an amorous conversation, or “gossip” for gossipy chat, or “invitation” for invitations and related responses, or “greetings” for introductory types of conversations. The conversational context can include one or more of any of the aforementioned examples, and/or any other suitable types of conversation& contexts. Each of the conversational context-specific language models may also correspond to one conversational context, and can be developed and trained in any suitable manner by a plurality of speakers before speech recognition runtime.

The speech recognition decoder 214 may further incorporate one or more emotional context-specific language models to identify an emotional context corresponding to the feature vectors. Also, the emotional context can include “anger” for hostile conversation, or “happy” for upbeat conversation, or “sad” for unhappy conversations, or “confused” or the like. The emotional context can include one or more of any of the aforementioned examples, and/or any other suitable types of emotional contexts. In one embodiment, each of the emotional context-specific language models corresponds to one emotional context, and can be developed and trained in any suitable manner by a plurality of speakers before speech recognition runtime. It should be understood these language models can include a permutation matrix of conversational/emotional models. For instance, the models can include a “dinner”/“happy” model, a “dinner”/“angry” model, a “gossip”/“confused” model, and the like.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Illustrative parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 can identify or select one of the reference patterns from the N-best list of single or multiple word reference patterns as recognized speech. In another example, the post-processor module(s) 216 can be used to convert acoustic data into text or digits for use with other aspects of the ASR system or other vehicle systems. In a further example, the post-processor module(s) 216 can be used to provide training feedback to the decoder 214 or pre-processor 212. More specifically, the post-processor 216 can be used to train acoustic models for the decoder module(s) 214, or to train adaptation parameters for the pre-processor module(s) 212.

The method or parts thereof can be implemented in a computer program product embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

### Method

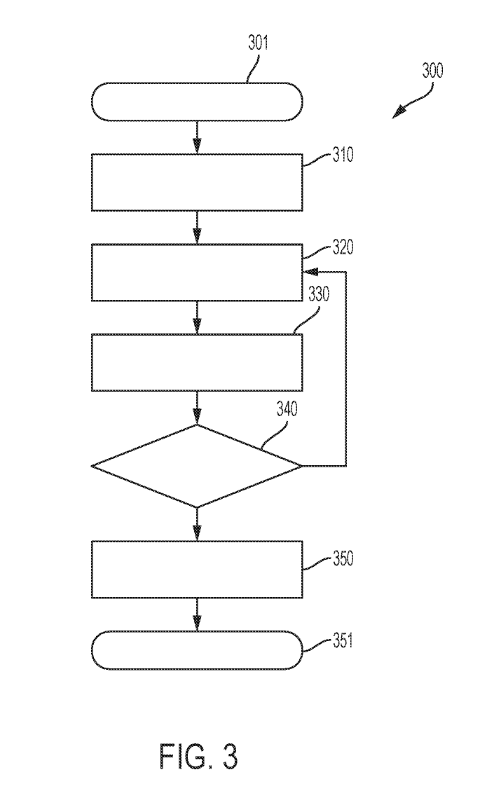

Turning now to FIG. 3, there is shown a method 300 that can be carried out using suitable programming of the automatic speech recognition system 210 of FIG. 2 within the operating environment of the vehicle telematics unit 30 as well as using suitable hardware and programming of the other components shown in FIG. 1. For example, speech recognition hardware, firmware, and software can resident on the computer 18, on one of the servers 82 in the data center 20, or on mobile computing device 57. In other words, the ASR system 210 can be resident in the telematics unit 30 or distributed across the vehicle 12 and the computer 18 and/or call center 20 and/or VRS 88 in any desired manner.

Such programming and use of the hardware described above will be apparent to those skilled in the art based on the above system description and the discussion of the method described below in conjunction with the remaining figures. Those skilled in the art will also recognize that the methods can be carried out using other ASR systems 210 within other operating environments. The method steps may or may not be sequentially processed, and the invention(s) may encompass any sequencing, overlap, or parallel processing of such steps.

Method 300 begins with 301 in which microphone 32 is configured to listen for speech within the interior of vehicle 12. In 301, moreover, telematics unit 30 is in constant communication with data center 20, for example, via wireless carrier system 14 for the purposes of the subscription service. Thus any recognized speech input picked up by microphone 32 as acoustic data that will be relayed/transmitted to data center 20 (i.e., VRS 88) through telematics unit 30 and carrier system 14. For example, the data can be sent via packet data transmissions via data over voice protocol, and/or via any other suitable manner. It should be understood that microphone 32 may alternatively be installed onto mobile computing device 57 and can listen while this device is in the vehicle interior. Thus, mobile computing device 57 may be in constant communication with data center 20 or it may be in constant communication with telematics unit 30.

In step 310, the microphone 32 listens to an instance of speech occurring in the vehicle interior and transmits it to data center 20. At data center 20, ASR system 210 then processes the speech data and enables VRS 88 to recognize whether that the speech data contains speech from at least two people in conversation. For instance, ASR system 210 provides acoustic data that represents the voice tones, voice inflections, and speech patterns of two different people speaking to each other. For example, the acoustic data may represent a conversation between a vehicle occupant (e.g., a vehicle operator) and another vehicle occupant (e.g., a vehicle passenger) speaking to each other in the vehicle interior. In another example, acoustic data may represent a conversation between a vehicle occupant (e.g., a vehicle operator/passenger) and a user of mobile computing device 57 (e.g., conversing with the vehicle occupant through the hands-free calling option of telematics unit 30). When such speech data shows it is from at least two people, method will move to step 320. In an alternative embodiment, the microphone 32 listens to an instance of speech occurring in the vehicle interior and transmits it to the ASR system 210 installed onto telematics unit 30, mobile computing device 57 or computer 18. It should be understood that VRS 88 may be, but is not limited to being, resident at data center 20 or in the memory of mobile computing device 57.

As such, VRS 88 will implement server 82/mobile computing device 57/computer 18/telematics unit 30 to activate microphone 32 to allow ASR system 210 to review the conversation while it is happening (i.e., in real-time), in step 320. As such, ASR system 210 can gather and process speech data that are potentially relevant to suggestions which may be made at some point during the conversation. Moreover, VRS 88 will remain silent while reviewing the conversation so as to not disturb the vehicle occupant and/or third party and disrupt the conversational flow (i.e., acting as a dictation service during this step). To achieve the effect of providing relevant suggestions, in step 320, ASR system 210 can enable the conversational context-specific language models, as discussed above, to identify at least one conversational context for the on-going conversation, or at least part of the conversation (e.g., a conversation subtopic). In this step, ASR system 210 may also enable the emotional context-specific language models, as discussed above, to identify the emotional context for the conversation, or for at least part of the conversation. During step 320, ASR system 210 may also identify and collect dynamic pieces of speech data to may be potentially relevant to and supportive of the suggestions such as, but not limited to, words identifying service provider types, for example, “restaurant”, words identifying service type genres, for example, ethnic food types (Italian, Greek, etc.), or words providing reference points, for example, near home, near destination (e.g., hotel).

Identifying the conversational and emotional context of the conversation allows VRS 88/server 82/mobile computing device 57/computer 18/telematics unit 30 to define the conversation in such a way which will support downstream aspects of method 300. For example, the conversation may be spliced into sections based upon categories such as, but not limited to, contextual topics. As such, VRS 88/server 82/mobile computing device 57/computer 18/telematics unit 30 may realize the conversation sections includes a topic of dinner that is in part happy regarding certain varieties of food type (e.g., pastas, Italian foods, pizza, etc.) and that is in part hesitant regarding other food types (e.g., burritos, Tex-Mex style, Mexican foods, tacos, etc.). As such, VRS 88/server 82/mobile computing device 57/computer 18/telematics unit 30 may provide a rank label to the food type understood as dinner/happy and another for the food type understood as dinner/hesitant (i.e., one generally considered lower than the food/happy topic). This helps the server 82 to classify an intent for the conversation. VRS 88/server 82/mobile computing device 57/computer 18/telematics unit 30 may additionally realize other sections include a topic of lodging that is in part positive regarding certain types of accommodations (e.g., hotels with a pool) and in part negative regarding other accommodations (e.g., motels having hourly room rates). As such, VRS 88/server 82/mobile computing device 57/computer 18/telematics unit 30 may provide one rank label to the lodging topic understood as accommodation/positive and a different rank label to the lodging topic understood as accommodation/negative. It should be understood these are only two examples of topics and others are possible. VRS 88/server 82/mobile computing device 57/computer 18/telematics unit 30 may also use the identified and collected dynamic speech data (discussed above) to help to arrive at this conversation definition so as to support downstream aspects of method 300. For example, the dynamic speech data may be used help identify the contextual topic of one or more conversation sections.

After some duration of time, VRS 88 will recognize a speech cue is made during the conversation from either the vehicle occupant or third party, at step 330. In one embodiment of method 300, the speech cue can be in the form of a query (i.e., a directed question for the VRS 88 to answer). For example, the vehicle occupant or third party may actively request VRS 88 to provide information regarding a service provided through one or more generally known VRS methodologies. In another embodiment of method 300, the speech cue can be in other forms such as, but not limited to, long silent pauses between the speakers, characterized words related to the conversational/emotional context, or certain speech tones/inflections. Using such speech cues enables VRS 88 to interrupt the conversation with suggestions. For example, after a long pause between conversant (e.g., four seconds), VRS 88 may provide suggestions “at this moment, I would like to provide some suggestions regarding the topics you have been discussing . . . ” VRS 88 may also repeat the topic to provide the vehicle occupant an understanding what kind of suggestions will be made as well as allow the occupant/third party the ability to ensure VRS 88 is on the right topic. For example, VRS 88 may ask the exemplary question “here are some suggestions to help you find dinner places . . . ” VRS 88 can further include supportive artificial intelligence-based executable instructions (i.e., an independent module such as a chatbot, talkbot, chatterbot, Bot, IM bot, interactive agent, or Artificial Conversational Entity, etc.), to assist in providing easily understood suggestions for the vehicle occupant and third party. VRS 88 may also retrieve this artificial intelligence support from the one or more suggestion databases 92.

In this step, moreover, VRS 88/server 82/mobile computing device 57/computer 18/telematics unit 30 will communicate with the one or more suggestion information databases 92 to retrieve suggestions based on the gathered and processed speech data from the conversation. In one embodiment, server 82 can retrieve information from database 92 being located at data center 20 as a subset of memory 84. In another embodiment, server 82 can retrieve information from database 92 being located at remote computer 18 (i.e., resident on the cloud). In addition, database 92 may access data center memory 84 and/or telematics memory 54 to retrieve previously recorded information such as, for example, preference information and/or conversation information in support of any provided suggestion information. As discussed above, VRS 88/server 82/mobile computing device 57/computer 18/telematics unit 30 may use one or more language models to determine which suggestions may be retrieved. For example, after deft ring the conversation and categorizing sections of the conversation, VRS 88/server 82/mobile computing device 57/computer 18/telematics unit 30 may search for certain conversational sections based on certain predefined rank labels (those having a high status) before other rank labels (those having lower status), to attempt to provide accurate suggestions or suggestions in their order of desire (as well as being in conformity with the intent of the conversation). In an effort to minimize user frustration, VRS 88/server 82/mobile computing device 57/computer 18/telematics unit 30 may only search for certain conversational sections having predefined rank labels of a certain status level and ignore any sections that fall below this status level. Thus, VRS 88/server 82/mobile computing device 57/computer 18/telematics unit 30 cannot retrieve low ranked conversational sections. It should also be understood that server 82 may also attain GPS information for vehicle 12 (from GPS module 40) to help support the retrieval of these suggestions. Once properly retrieved, VRS 88/server 82/mobile computing device 57/computer 18/telematics unit 30 will provide an audio announcement of the suggestions to the vehicle occupant and third party through audio system 36 (or the audio system on the mobile computing device 57). In this step, the suggestions may also be provided visually within the vehicle interior and exhibited via display 38 (or on the interface of mobile computing device 57). (For example, the suggestions could be a listing of movies currently at the box office.)

In step 340, after the suggestions have been announced, VRS 88/server 82/mobile computing device 57/computer 18/telematics unit 30 will determine whether the vehicle occupant or third party has affirmed at least one presented suggestion. For example, when being presented with a number of suggested restaurants, the vehicle occupant/third party may state they want to make a reservation at one of the suggested restaurants. As a result, when the vehicle occupant or third party confirms they have chosen at least one of the suggestions, method 300 will move to step 350. However, when they have chosen not to select one of the suggestions, method 300 will return to step 320 so ASR system 210 may return to reviewing the conversation in silence.

In step 350, when ASR system 210 is provided an accepted suggestion, VRS 88/server 82/mobile computing device 57/computer 1S/telematics unit 30 will contact the service provider 19 associated with the provided suggestion and may carryout a transaction in support of the interactions made during the previous steps. For example, when the vehicle occupant/third party has chosen an Italian restaurant, VRS 88/server 82/mobile computing device 57/computer 18/telematics unit 30 will contact the local computers at the restaurant for the purpose of negotiating a reservation time. When the service provider 19 communications are complete, method 300 will move to completion 351.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for.”

1. A method for detecting one or more cues in conversational speech, the method comprising:
recognizing (via a controller) a conversation between a vehicle occupant and at least one third party, wherein the vehicle is an automobile and wherein at least part of the conversation occurs in an interior of the vehicle;
reviewing silently (via the controller) the conversation in real-time;
receiving (at a controller) from the vehicle occupant or the third party a speech cue made during the conversation, wherein the speech cue is a question regarding a service that is actively directed to the controller by the vehicle occupant or third party or wherein the speech cue is a pause of at least four seconds in the conversation between the vehicle occupant and third party;
in response to the received speech cue, retrieving suggestion information based on the silent review of the conversation (via the controller) from one or more suggestion databases; and
providing (via the controller) an audio announcement of the suggestion information configured to be announced through an audio system located in a vehicle.

2. The method of claim 1, further comprising:
determining (via the controller) whether the vehicle occupant or the third party has, at least in part, confirmed the suggestion information after being announced through the audio system; and
contacting (via the controller) one or more service providers in response to a positive determination that the vehicle occupant or the third party has, at least in part, confirmed the suggestion information.

3. The method of claim 1, wherein:
the step of reviewing silently the conversation in real-time further comprising implementing one or more conversational context-specific language models to identify a conversational context for, at least a portion of, the conversation; and
the step of retrieving suggestion information from one or more suggestion databases is further based on the conversational context of the conversation.

4. The method of claim 3, wherein:
the step of reviewing silently the conversation in real-time further comprising implementing one or more emotional context-specific language models to identify an emotional context for, at least a portion of, the conversation; and
the step of retrieving suggestion information from one or more suggestion databases is further based on the emotional context of the conversation.

5. (canceled)

6. The method of claim 1, wherein the step of retrieving suggestion information from one or more suggestion databases is further based on previously recorded information for the vehicle occupant or the third party or both the vehicle occupant and the third party.

7. The method of claim 1, wherein the controller implements an Automated Voice Response System (VRS) to recognize the speech cue from the vehicle occupant or the third party and provide the suggestion information through the audio system.

8. A system for a detection of one or more cues in conversational speech, the system comprising:
an audio system located in a vehicle, the audio system configured to announce information, wherein the vehicle is an automobile; and
a memory configured to comprise one or more executable instructions;
a controller configured to execute the executable instructions; and
wherein the executable instructions enable the controller to:
recognize a conversation between a vehicle occupant and at least one third party, wherein at least part of the conversation occurs in an interior of the vehicle;
silently review the conversation in real-time for a speech cue;
receive the speech cue from the vehicle occupant or the third party, wherein the speech cue is a question regarding a service that is actively directed to the controller by the vehicle occupant or third party or wherein the speech cue is a pause of at least four seconds in the conversation between the vehicle occupant and third party;
in response to the received speech cue, retrieve suggestion information based on the silent review of the conversation from one or more suggestion databases; and
provide an audio announcement of the suggestion information configured to be announced through an audio system located in a vehicle.

9. The system of claim 8, wherein the executable instructions further enable the controller to determine whether the vehicle occupant or the third party has, at least in part, confirmed the suggestion information after being announced through the audio system; and
contact one or more service providers in response to a positive determination that the vehicle occupant or the third party has, at least in part, confirmed the suggestion information.

10. The system of claim 8, wherein:
the silent review the conversation further comprises the implementation of one or more conversational context-specific language models to identify a conversational context for, at least a portion of, the conversation; and
the retrieval of suggestion information from the one or more suggestion databases is further based on the conversational context of the conversation.

11. (canceled)

12. The system of claim 8, wherein the suggestion information from one or more suggestion databases is further based on previously recorded information for the vehicle occupant or the third party or both the vehicle occupant and the third party.

13. The system of claim 8, wherein the at least one third party is a mobile computing device user remotely located from the interior of the automobile.

14. The system of claim 8, wherein the controller implements an Automated Voice Response System (VRS) to recognize the speech cue from the vehicle occupant or the third party and provide the suggestion information through the audio system.

15. A non-transitory and machine-readable medium having stored thereon executable instructions adapted to detect one or more cues in conversational speech, which when provided to a controller and executed thereby, causes the controller to:
recognize a conversation within a cabin of a vehicle, wherein the vehicle is an automobile, the conversation between a vehicle occupant and at least one third party;
silently review the conversation in real-time for a speech cue, wherein the speech cue is a question regarding a service that is actively directed to the controller by the vehicle occupant or third party or wherein the speech cue is a pause of at least four seconds in the conversation between the vehicle occupant and third party;
receive the speech cue from the vehicle occupant or the third party;
in response to the received speech cue, retrieve suggestion information based on the silent review of the conversation from one or more suggestion databases; and
provide an audio announcement of the suggestion information configured to be announced through an audio system located in a vehicle.

16. The non-transitory and machine-readable medium of claim 15, further causes the controller to determine whether the vehicle occupant or the third party has, at least in part, confirmed the suggestion information after being announced through the audio system; and
contact one or more service providers in response to a positive determination that the vehicle occupant or the third party has, at least in part, confirmed the suggestion information.

17. The non-transitory and machine-readable medium of claim 15, wherein:
the silent review the conversation further comprises the implementation of one or more conversational context-specific language models to identify a conversational context for, at least a portion of, the conversation; and
the retrieval of suggestion information from the one or more suggestion databases is further based on the conversational context of the conversation.

18. (canceled)

19. The non-transitory and machine-readable medium of claim 15, wherein the at least one third party is another vehicle occupant.

20. The non-transitory and machine-readable medium of claim 15, wherein the controller implements an Automated Voice Response System (VRS) to recognize the speech cue from the vehicle occupant or the third party and provide the suggestion information through the audio system.
